(19) United States
(12) Patent Application Publication
(10) Pub. No.: US 2025/0273713 A1
(43) Pub. Date: Aug. 28, 2025

(54) METHOD FOR CONTROLLING PERFORMANCE OF FUEL CELL, AND FUEL CELL SYSTEM

(71) Applicant: TOYOTA JIDOSHA KABUSHIKI KAISHA, Toyota-shi (JP)

(72) Inventor: Atsushi YAMAMOTO, Toyota-shi (JP)

(73) Assignee: TOYOTA JIDOSHA KABUSHIKI KAISHA, Toyota-shi (JP)

(21) Appl. No.: 18/969,308

(22) Filed: Dec. 5, 2024

(30) Foreign Application Priority Data
Feb. 27, 2024 (JP) 2024-027752

(51) Int. Cl. H01M 8/04664; H01M 8/0438

(52) U.S. Cl. CPC H01M 8/04679; H01M 8/0438

(57) ABSTRACT

In order to control the performance of the fuel cell stack being pressurized by the restraining member, the deterioration of the fuel cell stack is evaluated so as to reduce the pressurizing force by the restraining member when the deterioration of the fuel cell stack can be acknowledged. By doing so, deterioration in performance of the fuel cell stack can be suppressed, and the service life can be extended.

### CROSS-REFERENCE TO RELATED APPLICATION

This application claims priority to Japanese Patent Application No. 2024-027752 filed on Feb. 27, 2024, incorporated herein by reference in its entirety.

### BACKGROUND

### 1. Technical Field

The present specification discloses a method for controlling performance of a fuel cell, and a fuel cell system.

### 2. Description of Related Art

A fuel cell is configured as a stack in which a plurality of cells is stacked. Fuel cell stacks may include disc springs to evenly pressurize cells that are stacked, so as to exhibit performance efficiently. Suppressing displacement of such disc springs, so as to maintain uniformity of in-plane pressure, thereby suppressing deterioration of performance of the fuel cells, is disclosed (Japanese Unexamined Patent Application Publication No. 2022-062425 (JP 2022-062425 A)).

### SUMMARY

There are cases in which, in conjunction with operation of the fuel cell, carbon and the like contained in a catalyst layer become oxidized and strength of the catalyst layer decreases. At this time, depending on pressurizing force that is applied, the catalyst layer may collapse, thereby causing the performance of the fuel cell to deteriorate. Deterioration in performance of the fuel cell may turn out to be exacerbated by the pressurizing force, initially intended to improve the performance of the fuel cell, thereby shortening operation life.

The present specification provides technology for controlling performance deterioration of fuel cells by controlling pressurizing force applied to the fuel cell stack, in accordance with a state of the fuel cell stack.

The technology disclosed in the present specification is embodied in a method of controlling the performance of a fuel cell stack. In this method, the fuel cell stack is pressurized by a restraining member. The method includes evaluating deterioration of the fuel cell stack, and reducing pressing force by the restraining member when deterioration of the fuel cell stack is confirmed.

According to this method, when deterioration of the fuel cell stack is confirmed, the pressurizing force applied to the fuel cell stack by the restraining member is reduced, whereby collapse of the catalyst layer due to the pressurizing force can be suppressed, and a rate of reduction of the performance of the fuel cell stack can be reduced, thereby prolong the operating life thereof.

The technology disclosed in the present specification is also embodied in a fuel cell system. This system includes a fuel cell stack that is pressurized by a restraining member, and a processor that evaluates deterioration of the fuel cell stack, and when deterioration of the fuel cell stack is confirmed, executes notification processing relating to reduction in pressurizing force by the restraining member.

According to this system, maintenance staff or the like is made aware of necessity of reducing the pressurizing force by the restraining member, by the notification processing regarding reducing the pressurizing force of the fuel cell stack by the restraining member. By reducing the pressurizing force, collapse of the catalyst layer can be suppressed, and the rate of reduction of the performance of the fuel cell stack can be reduced, thereby prolonging the operation life.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the influence of the fastening surface pressure of a fuel cell stack on the relationship between the operation time of the fuel cell stack and the fuel cell performance;

FIG. 2 is a cross-sectional view illustrating an example of a fuel cell stack including a restraining member;

FIG. 3 is a diagram showing processes of a control method;

FIG. 4 is a schematic diagram of a fuel cell system; and

FIG. 5 is a flowchart illustrating a process executed by the fuel cell system.

### DETAILED DESCRIPTION OF EMBODIMENTS

One embodiment of a method for controlling the performance of a fuel cell stack disclosed herein (hereinafter, also simply referred to as a control method) is a method in which the fuel cell stack is pressurized by a restraining member, and the deterioration of the fuel cell stack is evaluated, and when the deterioration of the fuel cell stack can be affirmed, the pressurizing force by the restraining member is reduced.

The control method is based on the finding by the inventors of a reduction in the thickness and porosity of the cathode catalyst layer due to the oxidation of the catalyst layer, in particular carbon, in the cathode catalyst layer, over the course of the stack operating time. It has also been found that such a change in the morphology of the catalyst layer leads to a decrease in the catalytic reaction and consequently to a decrease in the battery performance. In addition, it has been found that by reducing the pressing force on the stack, deterioration of the battery performance of the stack can be suppressed and the life can be prolonged.

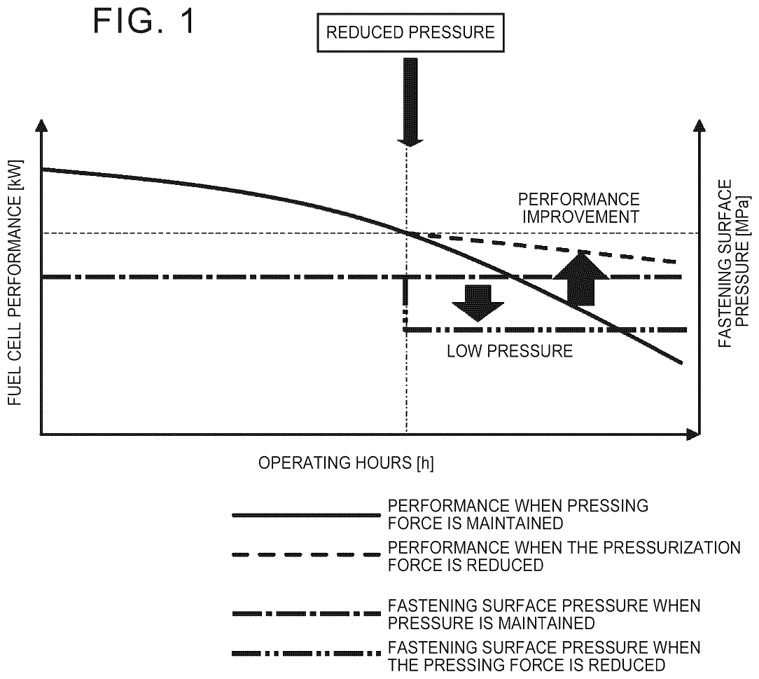

FIG. 1 shows the effect of the fastening surface pressure on the stack in relation to the operating time of the stack and the fuel cell performance. As shown in FIG. 1, by reducing the pressing force on the stack at a timing at which the deterioration of the stack can be affirmed, the performance deterioration rate of the stack can be relaxed, and the lifetime of the stack can be extended.

Another embodiment of the control method includes evaluating deterioration of the fuel cell stack based on whether an output value of the fuel cell stack satisfies a predetermined condition. According to this embodiment, deterioration of the fuel cell stack can be easily evaluated.

Another embodiment of the control method includes evaluating deterioration of the fuel cell stack based on whether a rate of decrease of an output value of the fuel cell stack satisfies a predetermined condition. According to this embodiment, deterioration of the fuel cell stack may be acknowledged early or with high accuracy.

Another embodiment of the control method includes evaluating deterioration of the fuel cell stack based on whether a gas diffusion resistance value of the fuel cell stack satisfies a predetermined condition. According to this embodiment, deterioration of the fuel cell stack may be acknowledged early or with high accuracy.

An embodiment of the fuel cell system disclosed herein includes a fuel cell system (hereinafter, also simply referred to as a system) including a fuel cell stack pressurized by a restraining member, and a processor for evaluating deterioration of the fuel cell stack, the processor performing a notification process regarding a decrease in the pressurizing force by the restraining member when the deterioration of the fuel cell stack can be acknowledged. The processor of the system may perform the evaluation specified in the various embodiments of the control method.

Hereinafter, a control method and a control system will be described with reference to the drawings as appropriate. In the present specification, the type of the fuel cell is not particularly limited, but it may be meaningful to apply the fuel cell to, for example, a polymer electrolyte fuel cell (PEFC). Further, the fuel cell is not particularly limited, but may be used as a driving power source for a moving body such as a vehicle, or may be used as a stationary type. In the following, for convenience of explanation, a fuel cell stack will be described, followed by a control method and system.

### Fuel Cell Stack

As shown in FIG. 1, a fuel cell stack (hereinafter, also simply referred to as a stack) 2 is configured by stacking a plurality of fuel cell cells (hereinafter, also simply referred to as cells) 4. The cell 4 is not particularly limited, and a known configuration can be adopted. In the stack 2, the cells 4 are stacked via a separator (not shown), and a terminal 6 and an insulating sheet 8 are disposed at end portions thereof, respectively.

The stack 2 is accommodated in an accommodation space Z formed by the stack case 10 and the end plate 12. In the accommodation space Z, the restraining member 20 is disposed between the top portion 10a of the stack case 10 and the stack 2.

The restraining member 20 is not particularly limited and may be any member capable of uniformly pressurizing the entire cell 4 by biasing the stack 2 against the end plate 12. For example, as shown in FIG. 1, the restraining member 20 includes a pair of pressing-plate 20a, 20b and a spring 22 serving as a biasing member. The pressing-plate 20a, 20b may have a size and stiffness sufficient to be able to exert the biasing force of the spring 22 on the entire surface of the cell 4.

The spring 22 is arranged so that the pressing-plate 20a, 20b can press the stack 2 in the stacking orientation of the cells 4 in the stack 2. For example, as shown in FIG. 1, a disc spring can be used. The springs 22 are arranged in a number and pattern sufficient to apply sufficient pressure to the stack 2. As the biasing member, in addition to various springs, an elastic body such as rubber can be used.

In the stack 2, by providing the restraining member 20, the cells 4 stacked in the stack 2 are uniformly pressurized. As a result, in the stack 2, the gas diffusion and the catalytic reaction are homogenized in the cell 4, so that the performance can be efficiently exhibited.

Next, a method of controlling the battery performance of the stack 2 will be described with reference to FIGS. 1 and 3. The control method is performed during maintenance of the stack 2. In the following description, a case where the stack 2 is mounted on fuel cell electric vehicle (FCEV) will be described as an example, and a control method to be executed at the time of maintenance of the vehicle will be described.

### Deterioration Evaluation Process

The deterioration evaluating process S10 evaluates the deterioration of the stack 2. Here, deterioration includes deterioration of the battery performance of the stack 2. For the deterioration evaluation, a suitable index (hereinafter, also referred to as a deterioration index) can be appropriately set based on a durability test of the stack 2 or the like.

The deterioration index is not particularly limited, but is, for example, an output value of the stack 2 or a reduction speed thereof. Deterioration can be easily detected by evaluating based on the output value (for example, P (kw)). Further, by evaluating the output value based on the decreasing speed, it is possible to detect the deterioration with high accuracy or to detect the stage of the indication of the deterioration at an early stage. The deterioration index is also, for example, a gas-diffusion resistivity (e.g., R (s/m)) or an increasing rate thereof. By evaluating based on the gas diffusion resistance value, it is possible to detect deterioration based on the decrease in the porosity of the catalyst layer. Further, by evaluating based on the rate of decrease of the gas diffusion resistance value, it is possible to detect deterioration with high accuracy and to detect the stage of the indication of deterioration at an early stage. It may be preferable to use a resistance value for the cathode electrode as the gas diffusion resistance value. For example, the difference in performance between the stack 2 when the air stoichiometric ratio is supplied sufficiently high and when the air stoichiometric ratio is supplied at 1 may be used.

Such an evaluation can be carried out by activating the operation of the stack 2 or in addition with a test device for known fuel cells. In the deterioration evaluation of the stack 2, the deterioration index described above can be performed alone or in combination.

### Deterioration Determination Process

The deterioration determination process S20 is a process of determining whether or not deterioration of the stack 2 can be affirmed based on the deterioration index. In order to affirm the deterioration of the stack 2, it is determined whether or not the above-described index satisfies a predetermined condition regarding the deterioration set in advance. The conditions are appropriately set in an operation durability test or the like for the stack 2. When it is possible to confirm the deterioration of the stack 2, the pressing force lowering process S30 is performed, and when it is not possible to confirm the deterioration, the control method is ended.

### Pressing Force Lowering Process

The pressing force lowering process S30 is a process of lowering the pressing force by the restraining member 20 when it is possible to affirm the deterioration of the stack 2. The lowering of the pressing force of the stack 2 by the restraining member 20 is not particularly limited. For example, in order to reduce the biasing force of the spring 22, various methods such as reducing the number of springs 22, changing the biasing force to the weak spring 22, reducing the thickness of the restraining member 20 itself, changing the restraining member 20, and eliminating the restraining member 20 can be used as the method of reducing the pressurizing force.

The degree of reduction in the pressing force is not particularly limited, and can be appropriately determined in accordance with the result of the durability test of the stack 2 or the like. According to the present inventors, it has been found that the reduction of the pressing force by the restraining member 20 is effective regardless of the degree thereof. In addition, it has been found that a decrease in the battery performance can be suppressed and an increase in the gas diffusion resistance value can be suppressed in accordance with the degree of reduction in the pressurizing force with respect to the stack 2.

According to this control method, deterioration of the battery performance of the stack 2 can be suppressed, and the life of the stack 2 can be prolonged.

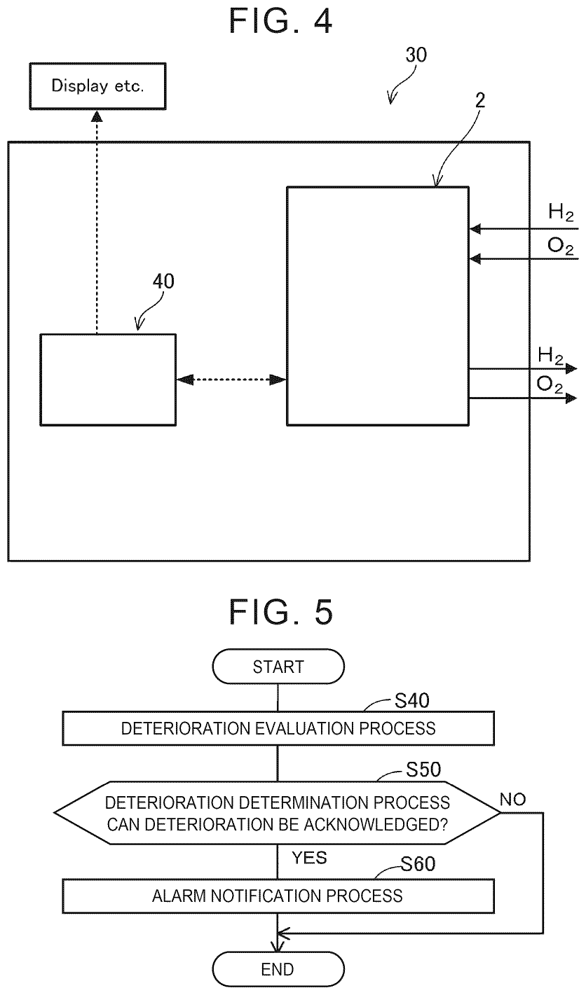

The control method can also be implemented, for example, as a control method executed by the fuel cell system. FIG. 4 shows an outline of an example of the fuel cell system 30, and FIG. 5 shows a flowchart of processing executed by the system 30. Note that, in FIG. 4, a supply path or the like of a gas or the like is briefly described.

The system 30 includes a stack 2 and a control device 40 that controls power generation in the stack 2. The control device 40 is an example of a processor in this specification. The control device 40 monitors the output value of the stack 2 by using an output value obtained from an output meter (not shown) or the like provided in the stack 2. In addition, the control device 40 controls supply, discharge, and circulation of hydrogen, which is a fuel gas, and oxygen, which is an oxidant gas. The control device 40 is configured to be capable of outputting information to an output device such as a display provided outside the system 30. In the control device 40, a program for determining the deterioration of the stack 2 and notifying an alarm regarding the decrease in the pressure by the restraining member 20 is executably stored.

Next, a control method executed by the system 30 will be described. In the following description, the features of the control method executed by the system 30 will be mainly described.

### Deterioration Evaluation Process

In the deterioration evaluation process S40, the deterioration of the stack 2 is evaluated. Since the control device 40 monitors the output value of the stack 2, the output value of the stack 2 is used as the deterioration index.

### Deterioration Determination Process

The deterioration determination process S50 determines whether the monitored output value is less than or equal to a preset output value. When the control device 40 can affirm the deterioration of the stack 2, an alarm notification process S60 is performed, and when the deterioration cannot be affirmed, the control method is ended.

### Alarm Notification Process

The pressing force lowering process S30 is a process of notifying an alarm requesting the lowering of the pressing force by the restraining member 20 when the control device 40 can affirm the deterioration of the stack 2. The alarm notification process is an example of the notification process related to the pressure drop disclosed herein. The control device 40 outputs to the display or the higher-level control device outside the system 30 that the timing of the decrease in the pressing force by the restraining member 20 has arrived, and ends the control method.

According to the system 30 and the control method, the system 30 detects the deterioration of the stack 2 and notifies an alarm related to the pressure drop caused by the restraining member 20. Therefore, the operator can reduce the pressing force on the stack 2 in addition to the periodic maintenance of the stack 2. In addition, it is possible to easily grasp the necessity of lowering the pressurizing force with respect to the stack 2 even at the time of periodic maintenance of the stack 2.

The system 30 described above may be the system 30 including the stack 2 mounted on the vehicle and the control device 40 mounted on the vehicle, or may be the system 30 including the stack 2 mounted on the vehicle and the control device 40 disposed outside the vehicle. It may also be a system 30 comprising a stationary stack 2 and a control device 40.

In the above-described system 30, the output value of the stack 2 is used as the deterioration index, but the present disclosure is not limited thereto. The system 30 includes a device capable of detecting other deterioration indices, and by acquiring index data from the device, the deterioration of the stack 2 can be evaluated and determined independently or in combination with other deterioration indices.

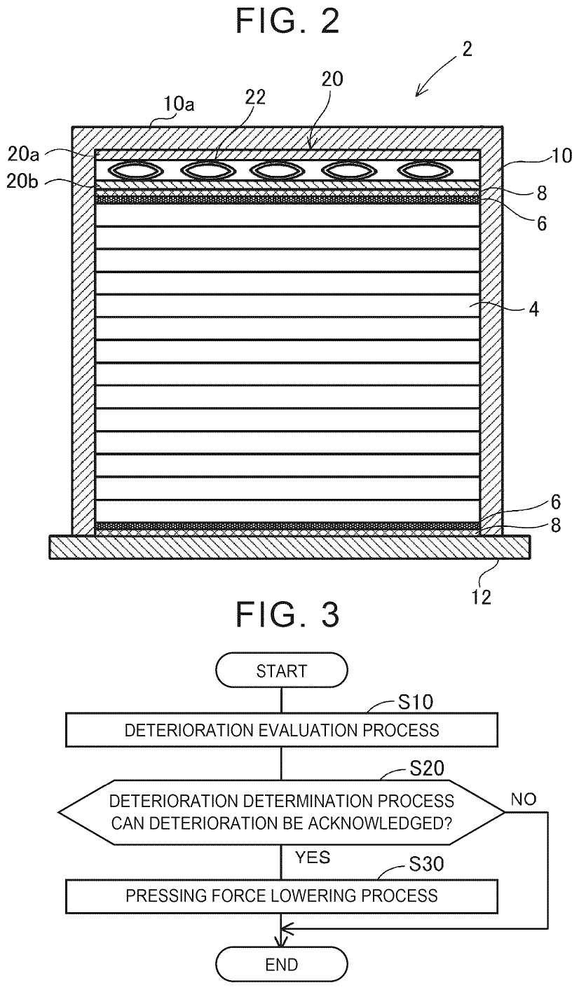

Although the stack 2 and the restraining member 20 shown in FIG. 2 are exemplified and described in the above embodiments, the stack and the restraining member disclosed in this specification are not limited thereto. The present disclosure is widely applied to a stack of known fuel cells and a restraining member for pressurizing the cells of the stack.

While specific examples of the technology disclosed in the present specification have been described in detail above, these examples are merely illustrative and do not limit the scope of the claims. The technology described in the claims includes various modifications and variations of the specific examples described above, for example, a method of controlling a fuel cell. The technical elements described in this specification or in the drawings may be used alone or in various combinations, and are not limited to the combinations described in the claims at the time of filing. The technology illustrated in the present specification or the drawings can achieve a plurality of objects at the same time, and has technical usefulness in achieving one of the objects.

What is claimed is:

1. A method of controlling performance of a fuel cell stack, in which the fuel cell stack is pressurized by a restraining member, the method comprising:
evaluating deterioration of the fuel cell stack; and
reducing pressing force by the restraining member when deterioration of the fuel cell stack is confirmed.

2. The method according to claim 1, further comprising evaluating deterioration of the fuel cell stack, based on whether an output value of the fuel cell stack satisfies a predetermined condition.

3. The method according to claim 1, further comprising evaluating deterioration of the fuel cell stack, based on whether a rate of decrease of an output value of the fuel cell stack satisfies a predetermined condition.

4. The method according to claim 1, further comprising evaluating deterioration of the fuel cell stack, based on whether a gas diffusion resistance value of the fuel cell stack satisfies a predetermined condition.

5. A fuel cell system comprising:
a fuel cell stack that is pressurized by a restraining member; and
a processor that evaluates deterioration of the fuel cell stack, and when deterioration of the fuel cell stack is confirmed, executes notification processing relating to reduction in pressurizing force by the restraining member.
